(19) United States
(12) Patent Application Publication
(10) Pub. No.: US 2015/0056462 A1
(43) Pub. Date: Feb. 26, 2015

(54) FLAME RETARDANT FILM

(71) Applicant: Illinois Tool Works Inc., Glenview, IL (US)

(72) Inventor: Michael J. Rancich, Houston, TX (US)

(21) Appl. No.: 14/311,776

(22) Filed: Jun. 23, 2014

Related U.S. Application Data
(60) Provisional application No. 61/869,436, filed on Aug. 23, 2013.

(51) Int. Cl. C08J 5/18; B32B 27/08

(52) U.S. Cl. CPC C08J 5/18; B32B 27/08; C08J 2323/06; B32B 2323/043; B32B 2307/514
USPC 428/516; 524/436

(57) ABSTRACT

A flame retardant film is a thin flexible film formulated from about 60.0% to 87.0% polyolefin, and about 6% to 30% Mg(OH)₂ flame retardant concentrate containing about 60% Mg(OH)₂. The film exhibits a flame spread index (FSI) of no more than 20 and a smoke generation index of no more than 60 when tested in accordance with ASTM E 84, Standard Test Method for Surface Burning Characteristics of Building Materials.

### CROSS-REFERENCE TO RELATED APPLICATION DATA

This application claims the benefit of and priority to Provisional U.S. Patent Application Ser. No. 61/869,436, filed Aug. 23, 2013, the disclosure of which is incorporated herein in its entirety.

### BACKGROUND

Films of all types are used in myriad industries. For example, thin films and laminations are used as vapor jacket materials for pipes, insulation facing for buildings, and jacketing for air/ducts plena. Such films can be used as water and/or air proofing membranes. These films prevent condensation build-up on piping, equipment, buildings and component surfaces which could, in time, have deleterious effects on the piping, equipment and building components if left unabated. Typically, these films are reinforced polymer and paper-based films.

One drawback to these films is that in addition to their barrier properties, they must also meet certain flame retardant properties. A common test for flame retardance of building materials is ASTM E 84, Standard Test Method for Surface Burning Characteristics of Building Materials. This test measures flame growth on the underside of a horizontal test specimen using the Steiner tunnel test protocol. The result is the derivation of a Flame Spread Index (FSI) which is a dimensionless number, where an asbestos-cement board has a value of 0 and a red oak board control sample has a value of 100. This test also measures smoke generation as a smoke-developed index (SDI), where an asbestos-cement board has a value of 0 and a red oak board control sample has a value of 100 The SDI is also derived using the Steiner tunnel test protocol.

Polyolefin based films typically do not pass this test at the level required for plenum applications. Films that pass are usually either less than 1/1000 inch (1 mil) thick or are thick sheets, greater than ⅛ inch thick, that require very high loading of flame retardants.

Halogenated compounds are commonly used in flame retardant materials. Such materials function well at moderate loadings to reduce the flammability of polyolefin and other polymers. However, halogenated materials tend to generate a considerable amount of smoke when burned. Another concern is that some of the more commonly used brominated flame retardant compounds are being phased out due to health and environmental concerns.

Accordingly, there is a need for a polyolefin based film that meets a desired the flame spread index requirement and a smoke developed index.

### SUMMARY

A flame retardant film comprises a thin flexible film comprising about 60.0% to about 87.0% polyolefin and about 6% to about 30% Mg(OH)₂ flame retardant concentrate containing about 60% Mg(OH)₂. The film exhibits a flame spread index (FSI) of no more than about 20 and a smoke generation index of no more than about 60 when tested in accordance with ASTM E 84, Standard Test Method for Surface Burning Characteristics of Building Materials.

In an embodiment, the film includes about 1.0% to about 10% TiO₂ concentrate containing about 70% TiO₂ and about 1% to about 6% of a UV inhibitor concentrate containing about 5% inhibitor. The film can have a thickness of about 3 mils to about 10 mils.

One suitable polyolefin is polyethylene (PE). The PE can be a high density polyethylene (HDPE). The HDPE can be an oriented HDPE.

An embodiment of the film is formulated from about 62.5% HDPE, about 25% to 30% Mg(OH)₂ flame retardant concentrate containing about 60% Mg(OH)₂. The film formulation can further include about 10% TiO₂ concentrate containing about 70% TiO₂ and about 2.5% of a UV inhibitor concentrate containing about 5% inhibitor.

The film can be formed as an oriented film. In an embodiment, the film can be formed from multiple plies of oriented film, the plies being laminated to one another by a lamination material. A suitable lamination material is a polyethylene. The lamination material can be substantially free from flame retardant material.

Each ply can be formulated from polyolefin present in a concentration of about 80 to about 85% and the flame retardant material is present in a concentration of about 6% to about 15%. The plies can further include TiO₂ concentrate present in a concentration of about 1.5% to about 2.0%, a UV inhibitor concentrate present in a concentration of about 2.5% to about 6.0%, and an antioxidant concentrate present in a concentration of about 1.0% to about 5.0%. In an embodiment, the lamination material is present at about 10% to about 20% of the total film weight. The oriented plies are laminated to one another with their respective orientations at an angle to one another between and excluding 0 degrees and 180 degrees. Such a film can include two plies. In an embodiment the includes three plies and at least two of the plies are laminated to one another with their respective orientations at an angle to one another between and excluding 0 degrees and 180 degrees.

These and other features and advantages of the present device will be apparent from the following description, taken in conjunction with the accompanying sheets of drawings, and in conjunction with the appended claims.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

A polyolefin film is formulated to meet a flame spread index requirement of less than 25 and a smoke developed index of less than 50. In an embodiment, the film is a thin film having a thickness of about 0.003 to 0.010 inches. One film can be formulated from high density polyethylene (HDPE). In an embodiment, magnesium hydroxide is used to reduce smoke generation without negatively affecting flame spread.

Table 1 below presents an example of one formulation of a 10 mil film that resulted in a flame spread index of 15 and a smoke developed index of 15. This film is indicated as Sample No. 10 in Table 3, below.

TABLE 1
Formulation for a 10 mil Film with E-84 results of 15/15.

| Material | Loading |
|---|---|
| HDPE | 62.5% |
| Mg(OH)₂ Flame Retardant Concentrate | 25 |
| (60% Mg(OH)₂) | |
| TiO2 Concentrate (70% TiO2) | 10 |
| UV Concentrate (5% UVI) | 2.5 |

Table 2 below presents an example of one formulation of a 3 mil oriented cross laminated film (2 ply film with a laminating layer between the two plies) that resulted in a flame spread index of 10 and a smoke developed index of 25. This film is indicated as Sample No. 11 in Table 3, below.

TABLE 2
Formulation for a 3 mil Oriented Cross Laminated
Film with E-84 results of 10/25.

| | Loading wt % | Weight % of |
|---|---|---|
| | of ply | total film |
| Material in oriented plies (2 required) | | |
| HDPE | 81% | 67.5% |
| Mg(OH)₂ Flame Retardant Concentrate | 10 | 8.33 |
| (60% Mg(OH)₂) | | |
| TiO2 Concentrate (70% TiO2) | 1.5 | 1.25 |
| UV Concentrate (5% UVI) | 5 | 4.17 |
| Antioxidant Concentrate (4% Antioxidant) | 2.5 | 2.08 |
| Material in laminating layer | | |
| Polyethylene | 100% | 16.7 |

As seen from Table 1, a 10 mil film (Sample No. 10) formulated from about 62.5% HDPE, about 25% Mg(OH)₂ flame retardant concentrate containing about 60% Mg(OH)₂, about 10% TiO₂ concentrate containing about 70% TiO₂ and about 2.5% of a UV inhibitor concentrate containing about 5% inhibitor was prepared.

And, as seen from Table 2, a 3 mil film (Sample 11) that included two plies, oriented and cross laminated, with each ply formulated from about 81% HDPE, about 10% Mg(OH)₂ flame retardant concentrate (containing about 60% Mg(OH)₂), about 1.5% TiO₂ concentrate (containing about 70% TiO₂), about 5% UV inhibitor concentrate (containing about 5% inhibitor) and 2.5% antioxidant concentrate (containing about 4% antioxidant) was prepared. The two plies were laminated with polyethylene. The polyethylene is present in a concentration of about 16.7% of the film by weight.

These films were compared to samples of various other films to compare the flame spread and smoke developed indices of the films. The flame retardant materials used were those commercially available from Techmer PM of Batavia, Ill. and Ampacet Corp. of Tarrytown, N.Y. The other film samples included a known polyvinylidene chloride (PVDC) jacket (Sample No. 1); an HDPE film with no flame retardant (Sample No. 2); compounded halogenated flame retardant films in flame retardant concentrations of 25% and 30% (Techmer FR, Sample Nos. 3 and 4); compounded non-halogenated flame retardant films in flame retardant concentrations of 15%, 30% and 40% (Techmer FR, Sample Nos. 5, 6 and 7); flame retardant films using a Mg(OH)₂ flame retardant concentrate in concentrations of 15% and 30% (Ampacet FR, Sample Nos. 8 and 9); the 10 mil film formulated from about 62.5% HDPE, about 25% Mg(OH)₂ flame retardant (Techmer FR, Sample 10, discussed above) containing about 60% Mg(OH)₂, about 10% TiO₂ concentrate containing about 70% TiO₂ and a UV inhibitor concentrate containing about 5% inhibitor; the 3 mil oriented cross laminated HDPE film compounded with 10% flame retardant (Ampacet FR, Sample No. 11, discussed above); a 5 mil oriented cross laminated HDPE film compounded with 10% flame retardant (Ampacet FR, Sample No. 12) and a 6.5 mil oriented cross laminated HDPE film compounded with 10% flame retardant (Ampacet FR, Sample No. 13). Both Techmer and Ampacet use a Mg(OH)₂ flame retardant formulated from 60% Mg(OH)₂ in polyethylene; Techmer non-halogenated flame retardant is proprietary; and Techmer halogenated flame retardants FR-1 and FR-2 contain ethylenebistetrabromophthalimide, antimony trioxide and other proprietary materials. The concentrations of each are proprietary. The results of the testing are provided in Table 3, below.

TABLE 3
Comparison of Flame Spread and Smoke Generation
Results for Various Thin Film Formulations.

| | | FR | Flame Spread | Smoke |
|---|---|---|---|---|
| Sample | | Concentrate | (PSI) | Generation (SDI) |
| No. | Material formulation | manufacturer | ASTM E84 | ASTM E84 |
| N/A | Application requirements | | ≦25 | ≦50 |
| 1¹ | Known jacket material PVDC - | | 0 | 50 |
| | 6 mil | | | |
| 2 | HDPE - 10 mil, no FR | | 10 | 105 |
| 3 | 25% hal FR-1 | Techmer | 5 | 90 |
| 4 | 30% hal FR-2 | Techmer | 15 | 85 |
| 5 | 15% non-hal FR | Techmer | 5 | 70 |
| 6 | 30% non-hal FR | Techmer | 0 | 75 |
| 7 | 40% non-hal FR | Techmer | 5 | 95 |
| 8 | 15% Mg(OH)₂ FR | Ampacet | 10 | 60 |
| 9 | 30% Mg(OH)₂ FR | Ampacet | 15 | 25 |
| 10 | 25% Mg(OH)₂ FR | Techmer | 15 | 15 |
| 11^{2,5} | 10% Mg(OH)₂ FR | Ampacet | 10 | 25 |
| 12^{3,5} | 10% Mg(OH)₂ FR | Ampacet | 15 | 35 |
| 13^{4,5} | 10% Mg(OH)₂ FR | Ampacet | 20 | 40 |

Notes:
¹Sample 1 was a 6 mil thick known PVDC jacket material.
²Sample 11 was formed as a 3 mil thick HDPE oriented cross laminated film and contains 0.5 mil non-FR polyethylene laminating layers.
³Sample 12 was formed as a 5 mil thick HDPE oriented cross laminated film and contains 0.5 mil non-FR polyethylene laminating layers.
⁴Sample 13 was formed as a 6.5 mil thick HDPE oriented cross laminated film and contains three (3) 0.5 mil non-FR polyethylene laminating layers; the 6.5 mil thick product is two (2) 3.0 mil cross laminated films laminated together.
⁵The FR loading in the cross laminated films is in the oriented plies only.

As can be readily seen from TABLE 3, above, a 10 mil film (Sample 10) formulated from about 62.5% HDPE, about 25% Mg(OH)₂ flame retardant concentrate containing about 60% Mg(OH)₂, about 10% TiO₂ concentrate containing about 70% TiO₂ and about 2.5% of a UV inhibitor concentrate containing about 5% inhibitor showed unexpectedly surprising results with a Flame Spread Index of 15 and a Smoke-Developed Index of 15. This is especially so in that a film using a higher loading of Techmer FR showed the same flame spread results, but higher smoke generation results, when at least the opposite would have been expected with respect to smoke generation. In addition, it was noted that a 3 mil (overall) thick oriented cross laminated HDPE film (Sample 11) having about 10% Mg(OH)₂ flame retardant concentrate containing about 60% Mg(OH)₂, about 1.5% TiO₂ concentrate containing about 70% TiO₂, and about 5.0% of a UV inhibitor concentrate containing about 5% inhibitor also showed unexpectedly surprising results with a Flame Spread Index of 10 and a Smoke-Developed Index of 25, which were also well within acceptable FSI and SDI limits of less than 25 and less than 50, respectively.

Moreover, the results in TABLE 3 show that while a only a slight improvement was seen with the halogenated flame retardants compared to non-flame retardant films, when magnesium dihydroxide is used as a flame retardant, smoke is greatly reduced with no or only a slight gain in flame spread. The acceptable levels or values for flame spread (FSI) are less than or equal to 25, and for smoke generation (SDI) are less than or equal to 50.

TABLE 3 also shows that the thin films (e.g., 3.0, 5.0 and 6.5 mil films) can be formed as cross laminated films, using cross laminating techniques, such as those disclosed in Barnes, U.S. Pat. No. 6,284,344, which is commonly assigned with the present application and is incorporated herein by reference in its entirety. These thin cross laminated films maintain a relatively low FR loading while exhibiting low flame spread and smoke generation indices (10/25, 15/35, 20/40 for the 3.0, 5.0 and 6.5 mil films, respectively). These films are also advantageous in that they exhibit higher resistance to tear propagation and higher tensile strength than non-cross laminated films and can thus be used in more challenging installations.

The above-discussed Flame Spread Index (FSI) and Smoke-Developed Index (SDI) tests were conducted in accordance with the aforementioned ASTM E 84, Standard Test Method for Surface Burning Characteristics of Building Materials to determine Flame Spread Index (FSI) and Smoke-Developed Index (SDI) for each sample.

Films can be produced using a film blowing method as well as other methods. For example, cast HDPE films will produce similar results. Such HDPE films can be formed by know extrusion processes. As noted above, oriented films, including biaxially oriented and monoaxially oriented films, such as oriented cross laminated HDPE films will produce like results. One such film is a high density polyethylene (HDPE) or a combination of HDPE and low density polyethylene (LDPE) such as that described in the aforementioned patent to Barnes (to which the flame retardant material has been added).

Other films and film forming methods will be recognized by those skilled in the art and are within the scope and spirit of the present disclosure. For example, it is contemplated that other suitable materials can be used in the manufacture of the present flame retardant film, such other suitable materials may include polypropylene or a variety of other polyolefin materials and blends, polyamides, polyethylene terephthalate and other thermoplastic materials compatible with the Mg(OH)₂ flame retardant concentrate. Other film forming methods include cast techniques, extrusion processes and the like.

It will be appreciated that the present films meet the 25/50 requirements for material used in plenum and other applications and are halogen free, thus addressing the considerable smoke generation consideration of halogenated compounds when burned and the health and environmental concerns of brominated flame retardant compounds

In the present disclosure, unless otherwise noted, all percentages (%) are percent by weight of the film or the ply as appropriate. In addition, the words “a” or “an” are to be taken to include both the singular and the plural. Conversely, any reference to plural items shall, where appropriate, include the singular.

All patents or patent applications referred to herein, are hereby incorporated herein by reference, whether or not specifically done so within the text of this disclosure.

From the foregoing it will be observed that numerous modification and variations can be effectuated without departing from the true spirit and scope of the novel concepts of the present film. It is to be understood that no limitation with respect to the specific embodiments illustrated is intended or should be inferred. The disclosure is intended to cover by the appended claims all such modifications as fall within the scope of the claims.

1. A flame retardant film, comprising:
a thin flexible film comprising about 60.0% to about 87.0% polyolefin and about 6% to about 30% Mg(OH)₂ flame retardant concentrate containing about 60% Mg(OH)₂, wherein the film exhibits a flame spread index (FSI) of no more than about 20 and a smoke generation index of no more than about 60 when tested in accordance with ASTM E 84, Standard Test Method for Surface Burning Characteristics of Building Materials.

2. The flame retardant film of claim 1 wherein the film includes about 1.0% to about 10% TiO₂ concentrate containing about 70% TiO₂ and about 1% to about 6% of a UV inhibitor concentrate containing about 5% inhibitor.

3. The flame retardant film of claim 1 wherein the film has a thickness of about 3 mils to about 10 mils.

4. The flame retardant film of claim 1 wherein the polyolefin is polyethylene.

5. The flame retardant film of claim 4 wherein the polyethylene is a high density polyethylene (HDPE).

6. The flame retardant film of claim 5 wherein the HDPE is an oriented HDPE.

7. The flame retardant film of claim 5 wherein the film is formulated from about 62.5% HDPE, about 25% to 30% Mg(OH)₂ flame retardant concentrate containing about 60% Mg(OH)₂.

8. The flame retardant film of claim 7 wherein the film formulation includes about 10% TiO₂ concentrate containing about 70% TiO₂ and about 2.5% of a UV inhibitor concentrate containing about 5% inhibitor.

9. The flame retardant film of claim 7 wherein the film is formed as an oriented film.

10. The flame retardant film of claim 1 wherein the film is formed from multiple plies of oriented film, the plies being laminated to one another by a lamination material.

11. The flame retardant film of claim 10 wherein the lamination material is a polyethylene and wherein the lamination material is substantially free from flame retardant material.

12. The flame retardant film of claim 11 wherein each ply is formulated from polyolefin present in a concentration of about 80 to about 85% and the flame retardant material is present in a concentration of about 6% to about 15%.

13. The flame retardant film of claim 12 wherein each ply further includes TiO₂ concentrate present in a concentration of about 1.5% to about 2.0%, a UV inhibitor concentrate present in a concentration of about 1.0% to about 6.0%, and an antioxidant concentrate present in a concentration of about 1.0% to about 5.0%.

14. The flame retardant film of claim 11 wherein the lamination material is present at about 10% to about 20% of the total film weight.

15. The flame retardant film of claim 10 wherein the oriented plies are laminated to one another with their respective orientations at an angle to one another between and excluding 0 degrees and 180 degrees.

16. The flame retardant film of claim 15 including two plies.

17. The flame retardant film of claim 15 including three plies and wherein at least two of the plies are laminated to one another with their respective orientations at an angle to one another between and excluding 0 degrees and 180 degrees.
